(19) United States
(12) Patent Application Publication
(10) Pub. No.: US 2002/0103084 A1
(43) Pub. Date: Aug. 1, 2002

(54) Soybean derived pesticide

(76) Inventors: Hsinhung John Hsu, Ventura, CA (US); Chun-Hua Chang, Ventura, CA (US)

Correspondence Address: RALPH D CHABOT, 2310 E PONDEROSA DR, SUITE 4, CAMARILLO, CA, 93010, US

(21) Appl. No.: 10/046,617

(22) Filed: Nov. 8, 2001

Related U.S. Application Data
(60) Provisional application No. 60/247,185, filed on Nov. 9, 2000.

(51) Int. Cl. A01N 63/00; A01N 65/00

(52) U.S. Cl. 504/117; 424/757

(57) ABSTRACT

The present invention is directed to a concentrated natural pesticide which contains a soybean component. The soybean component can be soybean extract, soybean slurry, soybean powder, or soybean paste. The soybean component is typically diluted with water and then sprayed onto plants to act as an insecticide or to control plant diseases. The concentrated natural pesticide can also comprise a soybean component and a second component which is selected from a group of oils, or an aldehyde such as cinnamic aldehyde. Although foliar application of the diluted pesticide is the preferred application, soil application can also be used.

### This application claims priority to U.S. Provisional Patent Application bearing serial No. 60/247185 dated Nov. 9, 2000.

### TECHNICAL FIELD

This invention pertains to the field of protecting plants from insects and disease.

### BACKGROUND OF THE INVENTION

The method most widely used for control of plant pests or pathogens is by the use of chemical pesticides. However, the majority chemical pesticides are harmful to the health of humans as well as other mammals and fish. Chemical pesticides also contribute to pollution of the environment. Recognizing the potential dangers associated with harmful chemical pesticides, there is a strong desire for discovery and utilization of alternative methods for control of plant pests and pathogens.

It has become widely known in the prior art that certain natural plants possess pesticidal properties. Natural plants such as garlic, pepper, pine, camphor, citronella, lemongrass, and eucalyptus have been used in the prior art as insect repellents, fungicides or insecticides. These plants or their extracts are usually used as a pesticide either individually or in combination with other chemicals or natural pesticides to promote effective control of pests or pathogens.

### DISCLOSURE OF THE INVENTION

The present invention is directed to a concentrated natural pesticide which contains a soybean component such as soybean extract, soybean slurry or soybean paste. Soybean paste is formed from soybean flour mixed with sufficient water to form a homogeneous paste.

The concentrated natural pesticide according to this invention can also be formulated so that the soybean component is combined with what is defined here as a pesticidal component. The pesticidal component can be either an oil component such as clove oil, cottonseed oil, or cinnamon oil, or the pesticidal component can be an aldehyde such as cinnamic aldehyde. Other oils which can also be used as a pesticidal component include: corn oil, mineral oil, rapeseed oil, vegetable oil, fish oil, rosemary oil, cedarwood oil, sweet orange oil, peppermint oil, citronella oil, pine oil, citrus oil, eucalyptus oil, and camphor oil.

The concentrated natural pesticide can be diluted with up to 1000 times water to form a use-dilution pesticide which can effectively protect plants against disease, insect infestation, etc.

When the concentrated natural pesticide comprises a soybean component and a pesticidal component, the preferred ratio is in the range between one to ten and ten to one by weight.

It has also been found that a concentrated natural pesticide can consist essentially of a soybean component and provide effective pesticidal qualities.

The soybean component of the concentrated natural pesticide can also be extracted from soybeans using an organic solvent such as ethyl alcohol and diluted with water.

### DETAILED DESCRIPTION OF THE INVENTION

The present invention is directed to a concentrated natural pesticide which contains a soybean component which can be diluted with water; or combined with a pesticidal component and thereafter diluted with water. In order to describe the scope of this invention, fourteen samples were prepared; some of which combined soybean with a pesticidal component. Each of the samples were diluted with water and thereafter tested.

The effectiveness for using soybean not only as an insecticide but as an overall effective natural pesticide was tested. Testing focused on the control of mites, house flies, white flies, powdery mildew disease, and microorganisms in soil. It is believed that these results would also be applicable to other common diseases and insects encountered in agriculture.

The preparation processes and tests are provided below.

Sample I: Soybean Extract

One pound of soybeans was added to nine pounds of water and allowed to stand for about 5 hours at ambient conditions. After the soybeans had time to become saturated with water, the water and soybeans were blended until a liquid slurry was obtained. Filtering of the slurry yielded soybean extract.

Sample II: Soybean Slurry

Same as Sample I except that no filtering occurs.

Soybean extract and soybean slurry prepared as described above are used in the following examples. Many of the following examples involve spraying solutions onto leaves. The amount sprayed in the subsequent examples is quantified as spraying an amount sufficient to totally wet the plant or leaf surface.

### EXAMPLE 1

### Preparation of Insecticide

A concentrated natural insecticide is prepared by mixing the following:

| | |
|---|---|
| Soybean Extract | 40 grams |
| Clove Oil | 10 grams |
| Cinnamon Oil | 10 grams |
| Cottonseed Oil | 40 grams |

The prepared concentrated insecticide is then diluted with 100 times water and thereafter sprayed onto avocado trees infested with Persia mites. A control sample using water was also tested. The results are as follows:

Number of Persia Mites
(Average per leaf)

| | Before | Six days | |
|---|---|---|---|
| Treatment | Spray | After Spray | Mortality (%) |
| Insecticide (100x) | 27.0 | 1.7 | 93.7 |
| Water (Control) | 16.6 | 11.5 | 30.7 |

The results indicate that combining 40 grams of Sample I (soybean extract), with clove oil, cinnamon oil, and cottonseed oil and thereafter diluted with 100 times water, produces an insecticide which is effective for the control of mites.

### EXAMPLE 2

### Control of Powdery Mildew on Lettuce Plants

Soybean Extract (Sample I) is diluted with 20, 50, and 100 times water; then sprayed onto lettuce plants infested with powdery mildew.

For purposes of presenting test results, a disease index which represents the severity of the disease present on a plant was created. This is a subjective assessment and is categorized in the following manner:

| Scale | % Infection |
|---|---|
| 0 | 0 |
| 1 | 1-10 |
| 2 | 11-20 |
| 3 | 21-50 |
| 4 | 51-100 |

The disease index is calculated by the following formula:

$$DI = \frac{[ ( {S}_{0} {L}_{0} ) + ( {S}_{1} {L}_{1} ) + ( {S}_{2} {L}_{2} ) + ( {S}_{3} {L}_{3} ) + ( {S}_{4} {L}_{4} ) ]}{{L}_{total} \times 4} \times 100$$

Where

DI=Disease index

S=Scale category (0, 1, 2, 3 or 4)

L=number of leaves per scale category

The degree of control (DC) represents the efficiency of the product in controlling the disease and is calculated by the following formula:

$$D C = \frac{{DI}_{non - treated area} - {DI}_{treated area}}{{DI}_{non - treated area}} \times 100$$

A degree of control of 0 represents no control and 100 represents total control of the disease.

The test results one day after spray application are as follows:

Powdery Mildew Test Results on Lettuce Plants

| Treatment | Disease Index | Degree of Control |
|---|---|---|
| Sample I (20x) | 0 | 100% |
| Sample I (50x) | 0 | 100% |
| Sample I (100x) | 0 | 100% |
| Control (Water) | 90 | 0% |

The results indicate that Sample I (soybean extract) diluted with water 20 times, 50 times and even 100 times presented 100% control of powdery mildew on lettuce plants one day after application. Water, as expected, provided no control.

### EXAMPLE 3

### Control of Powdery Mildew on Squash Plants

Soybean Slurry (Sample II) is diluted with 20, 50, 100, 500 and 1000 times of water and then sprayed onto squash plants infested with powdery mildew. The test results one day after the spray are as the following:

| Treatment | Disease Index | Degree of Control |
|---|---|---|
| Sample II (20x) | 3 | 85% |
| Sample II (50x) | 1 | 95% |
| Sample II (100x) | 2 | 90% |
| Sample II (500x) | 12 | 40% |
| Sample II (1000x) | 14 | 30% |
| Control (Water) | 20 | 0% |

Test results indicate that soybeans used in slurry form and diluted up to 1000 times water exhibits a level of control on powdery mildew consistent with the level of dilution. The only exception is when Sample II is only diluted with 20 times water. Although a high degree of control was realized, it was not as effective as Sample II diluted 50 times and 100 times. This discrepancy may be attributable to experimental error or possibly due to the 20 times dilution being too strong; negatively impacting the plant's defense system to some degree. In either case, the soybean slurry was used effectively for control of powdery mildew disease.

### EXAMPLE 4

### Control of Microorganism colonies

Into each of four beakers were mixed 1 gram of milled soybean powder (i.e. flour) with 10 grams of soil collected from a field used to grow strawberries and 5 grams of water. For control purposes, into each of four other beakers were mixed 10 grams of soil with 5 grams of water. The eight beakers were then kept at room temperature for 24 hours. Afterwards, one gram of soil was taken from each beaker for testing. Each of the soil samples were mixed with 2000 ml of water forming a dilution. Then, 1 ml was transferred from each dilution to a petri dish containing a culture medium, nutrient agar. The eight petri dishes were allowed 24 hours for culture growth in a growing chamber at 25° C. Each petri dish was counted for microorganism colonies. The results are listed below:

| | Average |
|---|---|
| Treatment | Colonies/Petri Dish |
| Soybean | 3 |
| Control | 40 |

The test results indicate that addition of soybean powder added to soil and water can reduce microorganism growth in the soil.

### EXAMPLE 5

### Control of Mites on Avocado w/Soybean Extract Dilution

The effectiveness of soybean extract (Sample I) sprayed upon avocado leaves infested with Persia mites is evaluated. Sample I is diluted at both 100 times and 500 times water and thereafter sprayed onto avocado trees infested with Persia mites. A control sample using water was also tested. The results are as follows:

Number of Persia Mites
(Average per leaf)

| | Before | Six days | |
|---|---|---|---|
| Treatment | Spray | After Spray | Mortality (%) |
| Sample I (100x) | 58 | 3 | 94.8 |
| Sample I (500x) | 42 | 3 | 92.9 |
| Water (Control) | 27 | 20 | 25.9 |

The results indicate that the soybean extract as represented by Sample I, can be diluted to at least 500 times water and provide effective use as an insecticide.

### EXAMPLE 6

### Control of House Flies Using Diluted Soybean Extract

Soybean extract was also tested for its effectiveness as an insecticide on house flies. For this test, the house flies were confined in cages covered by screens through which the insecticide could be sprayed.

Sample I is diluted at both 100 times and 500 times water and thereafter sprayed onto the cages. A control sample using water was also tested. Equal amounts of treatment, i.e. 5 cc were used. The results are as follows:

| | No. Flies | No. Dead Flies | |
|---|---|---|---|
| Treatment | Before Spray | After Spray | Mortality (%) |
| Sample I (100x) | 46 | 45 | 97.8 |
| Sample I (500x) | 33 | 30 | 90.9 |
| Water (Control) | 45 | 15 | 33.3 |

The results were obtained within one hour of spray application. It was determined that soybean extract, made according to Sample I, when diluted with 500 times water, was effective as an insecticide, killing over 90% of the flies.

### EXAMPLE 7

### Control of White Flies on Cucumber Plants with Diluted Soybean Extract

The effectiveness of soybean extract (Sample I) sprayed on cucumber plants infested with white flies is evaluated. Sample I is diluted at both 100 times and 500 times water and thereafter sprayed onto cucumber plants infested with white flies. A control sample using water was also tested.

The results are as follows:

| | No. Flies | No. Dead Flies | |
|---|---|---|---|
| Treatment | Before Spray | After Spray | Mortality (%) |
| Sample I (100x) | 162 | 133 | 82.1 |
| Sample I (500x) | 148 | 120 | 81.1 |
| Water (Control) | 114 | 15 | 13.2 |

The results indicate that soybean extract, in the form of Sample I, when diluted to 500 times water, was effective in killing over 80% of white flies tested.

The following examples study pesticidal effectiveness of mixing soybean extract with various oils.

### EXAMPLE 8

### Control of Powdery Mildew on Lettuce Plants w/Soybean-Clove Oil Pesticide

Samples IV, V and VI represent different ratios of Soybean Extract (Sample I) with clove oil. These differing ratios were made to observe any differences in pesticidal effectiveness to lettuce infested with powdery mildew. The amount of soybean extract to clove oil are as follows:

| | Soybean Extract | |
|---|---|---|
| | (Sample I) | Clove Oil |
| Sample IV | 10 grams | 90 grams |
| Sample V | 70 grams | 30 grams |
| Sample VI | 30 grams | 70 grams |

Samples IV, V, and VI were then diluted with 100 times water and sprayed onto lettuce plants infested with powdery mildew as were plants used as control which were sprayed with either pure water or clove oil diluted 100 times water. The test results one day after the spray are as the following:

| Treatment | Disease Index | Degree of Control (%) |
|---|---|---|
| Sample IV (100×) | 0 | 100 |
| Sample V (100×) | 0 | 100 |
| Sample VI (100×) | 10 | 71 |
| Clove Oil (100×) | 12 | 66 |
| Control (Water) | 35 | 0 |

The results indicate a ratio of soybean extract/clove oil of between 1 to 9 and 7 to 3 provide maximum control of powdery mildew. However, a ratio of 3 to 7 (Sample VI), only provided marginal improved control over clove oil only.

### EXAMPLE 9

### Control of Mites w/Sovbean-Clove Oil Insecticide

The same samples used in Example 5 are also used in testing effectiveness for control of mites. The samples are diluted with 100 times water and sprayed onto avocado trees infested with Persia mites. Two controls were used: the first, pure water; and, the second, clove oil diluted 100 times with water. The test results are as the following:

Average Number
Mites per leaf

| | Before | One Day | |
|---|---|---|---|
| Treatment | Spray | After Spray | Mortality (%) |
| Sample IV (100×) | 40 | 0 | 100.0 |
| Sample V (100×) | 38 | 3 | 92.1 |
| Sample VI (100×) | 35 | 0 | 100.0 |
| Clove Oil (100×) | 38 | 4 | 89.5 |
| Control (Water) | 25 | 20 | 20.0 |

The results indicates combining clove oil and soybean extract is a more effective pesticide when compared to clove oil diluted by the same quantity of water.

### EXAMPLE 10

### Control of Powdery Mildew on Lettuce Plants w/Soybean Extract Pesticide

Instead of using the soybean extract identified as Sample I, the following Soybean Extracts are prepared in the same manner as for Sample I, using different soybean:water ratios:

| | Soybean | Water |
|---|---|---|
| Sample VII | 10 grams | 90 grams |
| Sample VIII | 20 grams | 80 grams |
| Sample IX | 30 grams | 70 grams |

The samples prepared are then diluted with 100 times water and sprayed onto lettuce plants infested with powdery mildew. The test results one day after the spray are as the following:

| Treatment | Disease Index | Degree of Control (%) |
|---|---|---|
| Sample VII (100×) | 25 | 29 |
| Sample VIII (100×) | 14 | 60 |
| Sample IX (100×) | 12 | 66 |
| Control (Water) | 35 | 0 |

### EXAMPLE 11

### Control of Mites w/Sovbean Extract Pesticide

The same samples used in Example 7 are also used in testing the control of mites. The samples are diluted with 100 times water and sprayed onto avocado trees infested with Persia mites. The test results are as the following:

Average No. of Mites

| | Before | One Day | |
|---|---|---|---|
| Treatment | Spray | After Spray | Mortality (%) |
| Sample VII (100×) | 28 | 3 | 89.3 |
| Sample VIII (100×) | 39 | 4 | 89.7 |
| Sample IX (100×) | 33 | 3 | 90.9 |
| Control (Water) | 25 | 20 | 20.0 |

### EXAMPLE 12

### Control of Mites w/Soybean-Alcohol Pesticide

Soybean Extract is prepared using mixtures of ethyl alcohol and water. These samples are prepared in the following manner:

| | Soybean | Alcohol | Water |
|---|---|---|---|
| Sample X | 10 grams | 45 grams | 45 grams |
| Sample XI | 20 grams | 40 grams | 40 grams |
| Sample XII | 30 grams | 35 grams | 35 grams |

The samples prepared are then diluted with 100 times water and sprayed onto lettuce plants infested with powdery mildew. The test results one day after the spray are as the following:

| Treatment | Disease Index | Degree of Control (%) |
|---|---|---|
| Sample X (100×) | 7 | 80 |
| Sample XI (100×) | 10 | 71 |
| Sample XII (100×) | 15 | 57 |
| 50/50 Water/alcohol mix | 25 | 29 |
| Control (Water) | 35 | 0 |

### EXAMPLE 13

### Control of Mites w/Soybean-Alcohol Insecticide

The same samples used in Example 12 are also used in testing the control of mites. The samples are diluted with 100 times water and sprayed onto avocado trees infested with Persia mites. The test results are as the following:

| | Average No. of Mites | | |
|---|---|---|---|
| | Before | One Day | |
| Treatment | Spray | After Spray | Mortality (%) |
| Sample X (100×) | 38 | 3 | 92.1 |
| Sample XI (100×) | 37 | 2 | 94.5 |
| Sample XII (100×) | 31 | 1 | 96.8 |
| 50/50 Water/alcohol mix | 28 | 3 | 89.3 |
| Control (Water) | 25 | 20 | 20.0 |

### EXAMPLE 14

### Soybean extract Mixed with an Aldehyde

For this test, a pesticide was prepared comprising 80 grams cinnamic aldehyde and 20 grams soybean extract made according to Sample I. The prepared concentrated pesticide was then diluted with 200 times water and thereafter sprayed onto avocado trees infested with Persia mites. The number of mites reported below is an average number of mites present per leaf. An equivalent amount of cinnamic aldehyde was also diluted with 200 times water and tested. A water spray was also used as a control. The results are as follows:

| | No. Mites | No. Mites | |
|---|---|---|---|
| | Before | 6 Days | |
| Treatment | Spray | After Spray | Mortality (%) |
| Pesticide (200x) | 28.6 | 5.2 | 81.8 |
| Cinnamic Aldehyde (200x) | 25.3 | 10.8 | 57.3 |
| Water (Control) | 16.6 | 11.5 | 30.7 |

The results indicate that when cinnamic aldehyde is combined with soybean extract and diluted with water, it is a more effective pesticide than if using diluted cinnamic aldehyde alone.

We claim:

1. A concentrated natural pesticide which consists essentially of a soybean component which can be diluted with water forming a use-dilution pesticide.

2. The use-dilution pesticide of claim 1 wherein said concentrated natural pesticide can be diluted with up to 100 times water.

3. The use-dilution pesticide of claim 1 wherein said concentrated natural pesticide can be diluted with up to 500 times water.

4. The use-dilution pesticide of claim 1 wherein said concentrated natural pesticide can be diluted with up to 1000 times water.

5. The soybean component of claim 1 which is selected from the group consisting of soybean extract, soybean powder, soybean paste, or soybean slurry.

6. A concentrated natural pesticide which consists essentially of a soybean component which can be extracted with an organic solvent such that when said concentrated natural pesticide is diluted with water, there is formed a use-dilution pesticide.

7. The use-dilution pesticide of claim 6 wherein said concentrated natural pesticide can be diluted with up to 1000 times water.

8. The use-dilution pesticide of claim 6 wherein said organic solvent is ethyl alcohol.

9. A concentrated natural pesticide comprising a soybean component and at least one pesticidal component such that when said concentrated natural pesticide is diluted with water, there is formed a use-dilution pesticide.

10. The concentrated natural pesticide of claim 9 wherein the ratio of said soybean component to said pesticidal component is in the range between one to ten and ten to one by weight.

11. The concentrated natural pesticide of claim 9 wherein said pesticidal component is selected from the group consisting of clove oil, cotton seed oil and cinnamon oil.

12. The concentrated natural pesticide of claim 9 wherein said pesticidal component is selected from the group consisting of clove oil, cotton seed oil, cinnamon oil, corn oil, mineral oil, rapeseed oil, vegetable oil, fish oil, rosemary oil, cedarwood oil, sweet orange oil, peppermint oil, citronella oil, pine oil, citrus oil, eucalyptus oil, and camphor oil.

13. The use-dilution pesticide of claim 9 which comprises said concentrated natural pesticide diluted with up to 100 times water.

14. The use-dilution pesticide of claim 9 which comprises said concentrated natural pesticide diluted with up to 1000 times water.

15. A concentrated natural pesticide comprising a soybean component and at least one pesticidal component such that when said concentrated natural pesticide is diluted with water, there is formed a use-dilution pesticide.

16. The concentrated natural pesticide of claim 15 where said pesticidal component is cinnamic aldehyde.
